(19) United States
(12) Patent Application Publication
(10) Pub. No.: US 2007/0037559 A1
(43) Pub. Date: Feb. 15, 2007

(54) Proximity triggered communication system

(75) Inventors: Terrance Kaiserman, Loxahatchee, FL (US); John Gentile, Montchair, NJ (US); Anthony Gentile, New York, NY (US); Andrew Ferber, New York, NY (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: P-Inc. Holdings, LLC

(21) Appl. No.: 11/502,812

(22) Filed: Aug. 11, 2006

Related U.S. Application Data
(60) Provisional application No. 60/707,338, filed on Aug. 11, 2005.

(51) Int. Cl. H04L 12/58; H04Q 7/22

(52) U.S. Cl. 455/414.2; 455/412.1

(57) ABSTRACT

A system for broadcasting a sound and/or visual concerning a subject to a person upon detecting a presence in the vicinity of a design indicative of the subject. The system includes a sensor proximal to the design. When the sensor detects a person or object proximal the design, a sound or visual concerning the subject of the design is broadcast. In one implementation, the design is a floor advertisement for a product, and when a person steps on the floor advertisement an audible promotional message concerning the product is broadcast within earshot of the person.

### RELATED APPLICATION

The present application claims the benefit of U.S. Provisional Application Ser. No. 60/707,338, titled “PROXIMITY TRIGGERED COMMUNICATION SYSTEM,” filed on Aug. 11, 2005, the contents of which is hereby incorporated by reference in its entirety.

### FIELD

Communication systems are shown and described, and more particularly, communication systems that trigger a response (e.g., a broadcast, light, or a sound) or provide a visual display or indication upon detecting a presence in the vicinity of a design indicative of the subject of the sound or visual are shown and described.

### BACKGROUND

There are many circumstances in which it is beneficial to communicate with a person when the person is proximal the subject of the communication. For, example, marketers employ “point of sale” advertisements to promote the purchase of products or services. Point-of-sale advertising is important to vendors because it provides the last chance to persuade a customer to choose a particular brand. Further, as competition increases between brands and brands tend to offer similar features at similar prices, it is more likely than ever that a consumer will select a brand at the point of sale. Accordingly, vendors desire point of sale displays that grab the attention of potential buyers the potential buyers are contemplating a purchase.

### SUMMARY

A communication system includes a floor unit comprising a design concerning a subject and a message device. The floor unit detects the presence of at least one person or object proximal the design and the message device generates a message related to said subject.

A communication system includes a base layer, a dielectric layer having a first side facing the base layer and a second side facing away from the base layer, wherein the second side has a design concerning a subject thereon, a transmitter unit, and a message device, wherein the base layer has at least one contact-activated area comprising a conductive ink printed thereon, the first side of the dielectric layer has at least one contact-making area comprising a conductive ink printed thereon, the first side of the dielectric layer further comprises a dielectric material, the dielectric material biases the contact-making area away from the contact-activated area, and when a force is applied to the design, the contact-making area electrically communicates with the contact-activated area, and the message device generates a message concerning the subject of the design.

A communication system includes a housing, an insert disposed in the housing, the insert having a design concerning a subject thereon and at least one contact-activated area comprising a touch-sensitive switch, and a message device, wherein when the touch-sensitive switch is touched, the message device generates a message concerning the subject.

A communication system includes a housing, an insert associated with the housing, the insert having a design concerning a subject thereon, a message device, a coupon dispenser for dispensing a plurality of coupons, wherein each coupon has a conductive trigger region, the insert has a detection area comprising a touch-sensitive switch, and when the trigger region is placed adjacent the detection area, the message device generates a message about the subject.

A communications system includes a layered unit having at least one contact-activated region, a circuit layer and an overlay bearing a design concerning a subject, and a message device, wherein the layered unit is disposed on a surface, and when one of the contact-activated regions is contacted, the message device generates a message concerning the subject.

### BRIEF DESCRIPTIONS OF THE DRAWINGS

The following detailed description, given by way of example, but not intended to limit the invention solely to the specific embodiments described, may best be understood in conjunction with the accompanying drawings wherein like reference numerals denote like elements and parts, in which:

FIG. 1 is a plan view of a system for communicating promotional messages to persons proximal a floor unit.

FIG. 2 shows an exploded view of an embodiment of a floor unit like that depicted in FIG. 1.

FIG. 2A shows an exploded view of a floor unit like that depicted in FIGS. 1 and 2.

FIG. 2B shows an exemplary base layer conductive ink trace layout, according to an embodiment.

FIG. 2C shows an exemplary dielectric layer with conductive ink contacts.

FIG. 2D shows a cross-section view of a switching circuit in a switch open position.

FIG. 2E shows a cross-sectional view of a switching circuit in a switch closed position.

FIG. 2F shows a cross-sectional view of an embodiment of transmitter portion that includes a generally convex domed upper surface.

FIG. 3 shows a preferred embodiment of the invention in which promotional messages are communicated to persons proximal a shelf unit.

FIG. 4 shows a system for communicating promotional messages to persons proximal a vertical surface.

FIG. 5 shows an audio unit suitable for use with the FIG. 1 embodiment.

FIG. 6 shows a cross-section of the audio unit of FIG. 5.

FIG. 7 is a block diagram of preferred embodiment of the transmitter portion of the circuit layer depicted in FIG. 2.

FIG. 8 is a block diagram of a preferred embodiment of an audio unit according to the invention.

FIG. 9 is a circuit diagram of a preferred embodiment of the circuit layer depicted in FIG. 2.

FIG. 10 is a circuit diagram of a preferred embodiment of the audio unit depicted in FIG. 5.

FIG. 11 is a diagram depicting a scheme for updating messages stored in the audio unit of FIG. 5.

FIG. 12 shows a preferred embodiment of the invention in which promotional messages are communicated to persons proximal a coupon unit.

FIG. 13 illustrates an alternative embodiment of a floor unit that is a piezo-based floor unit.

FIG. 14 illustrates a thermochromic floor unit that has the ability to change color.

### DETAILED DESCRIPTION

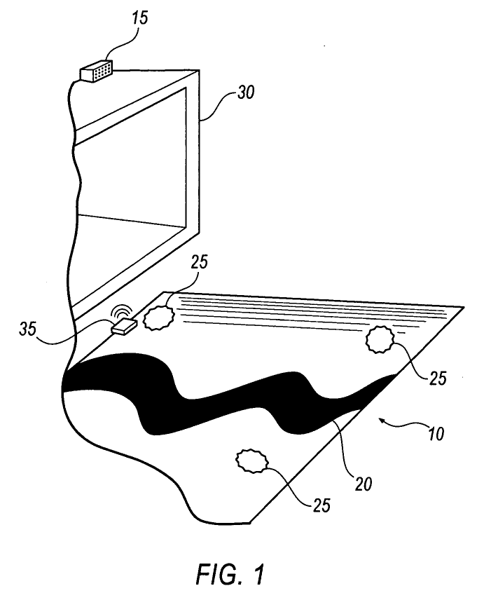

As described below, an embodiment of a communication system is provided which communicates a promotional or informational signal concerning a subject to a person upon detecting the person's presence in the vicinity of a design indicative of the subject. FIG. 1 depicts one preferred embodiment of the communication system.

FIG. 1 is a plan view of a system for communicating promotional messages to persons proximal a floor unit. The system of FIG. 1 is suitable for use in a retail store such as a supermarket. The system includes a floor unit 10 and an audio unit 15. The floor unit bears a design 20 and includes several contact-activated areas 25. The audio unit 15 is positioned on a shelf 30 of a supermarket aisle (e.g. in a “price channel”).

The contact-activated areas 25 of FIG. 1 are pressure-activated switches. When a person steps on one of the contact-activated areas 25 of the floor unit 10, a transmitter 35 is activated to transmit a detection signal to the audio unit 15. Likewise, when an object such as a shopping cart contacts one of the areas 25, the transmitter 35 is activated to transmit the detection signal. In any case, the detection signal is preferably transmitted via infra red (IR) or radio frequency (RF) transmission. However, the detection signal may further include, but is not limited to, radio-frequency, infrared, Bluetooth, ultrasonic, microwave, ZigBee, direct wire methods, or combinations thereof. Upon receiving the detection signal, the audio unit 15 generates a sound that is related to product depicted by design 20. The product-related sound may take the form of, for instance, a promotional message, a narrative, a “jingle,” a combination of narrative and jingle, or some other type of audible message.

The audio unit 15 is preferably placed at a shelf position that is near the shelf position of the product which is the subject of design 20 and product-related sound. In this manner a prospective buyer views design 20, and upon stepping on design 20, has his/her attention drawn to the product's position on the shelf 30 as the source of the sound. In addition, the sound serves to promote the product. The combined effect is to have the prospective buyer exposed to a combination of visual and audible promotions that help the prospective buyer locate the product while simultaneously prompting him/her to purchase the product.

It should be noted that although FIG. 1 depicts a product as the subject of design 20, other subjects such as services may be used.

It should be further noted that although FIG. 1 depicts only contact-activated areas 25, it is possible to supplement or replace the contact-activated areas with non-contact sensors. For example, an ultrasound, IR or RF sensor could be used to detect a person or shopping cart in the vicinity of the floor unit 10. Further, such sensor may or may not be a motion detecting sensor.

As an optional feature of the FIG. 1 embodiment, the audio unit 15 stores multiple sounds. In such embodiment, the sound that is played upon each activation of a contact-activated area is determined by the audio unit's programming. Thus, the sound a person hears when stepping on the floor unit 10 could be varied.

Further, each contact-activated area 25 on the floor unit could be associated with its own sound so that, for example, each time a first area 25 is activated a first sound associated with the first area 25 is generated, and each time a second area 25 is activated a second sound associated with the second area 25 is generated. Still further, each contact-activated area 25 on the floor unit 10 could be associated with its own design 20 and sound so that, for example, each time a first area 25 bearing a first design 20 is activated a first sound relating to the subject of the first design 20 is generated, and each time a second area 25 bearing a second design is activated a second sound associated with the subject of the second design 20 is generated. Moreover, a floor unit 10 may include more than two contact-activated areas 25 wherein each contact-activated area is associated with its own design and/or sound.

In any event, it is preferable that the sound or sounds stored in the audio unit 15 can be changed.

Another optional feature is to link one or more of the contact-activated areas 25 to a visual display or signal indicating the product's location. For example, in one embodiment, activation of one of contact-activated areas 25 causes a light to turn on near the product. In another example, activation of one of contact-activated 25 areas triggers a video presentation. In yet another example, activation of one of contact-activated areas 25 triggers projection of a moving image on a wall or screen.

For purposes of this description, all possible sounds and visuals that could be generated in response to detection by one of the sensors may be collectively referred to as messages.

Still another optional feature is an interrupt prevention feature. The interrupt prevention feature inhibits the contact-activated area(s) from initiating generation of a sound during a time when another sound is being generated. That is, once a contact-activated area 25 has been activated and a sound is being generated, the complete sound must be generated before generation of a new sound is begun, even if the new sound is the same as the sound being generated. In this fashion, sounds do not interrupt one another. Further, a minimum delay feature could be implemented. The minimum delay feature requires that a minimum amount of time passes between the completion of first sound generation and the initiation of a second sound generation. Accordingly, the minimum delay feature prevents rapid repeated activation of the system (e.g. by a child) by rendering the system non-responsive for a predetermined period of time (e.g. 10 seconds) immediately following the completion of a generated sound.

Both the interrupt prevention features and minimum delay features are applicable to the embodiments where a visual is generated in response to activation of a contact-activated area. In such a context, the interrupt prevention feature prevents a generated visual from being interrupted by activation of a contact-activated area, and the minimum delay feature guarantees a minimum delay between the completion of a first visual generation and the initiation of a second visual generation.

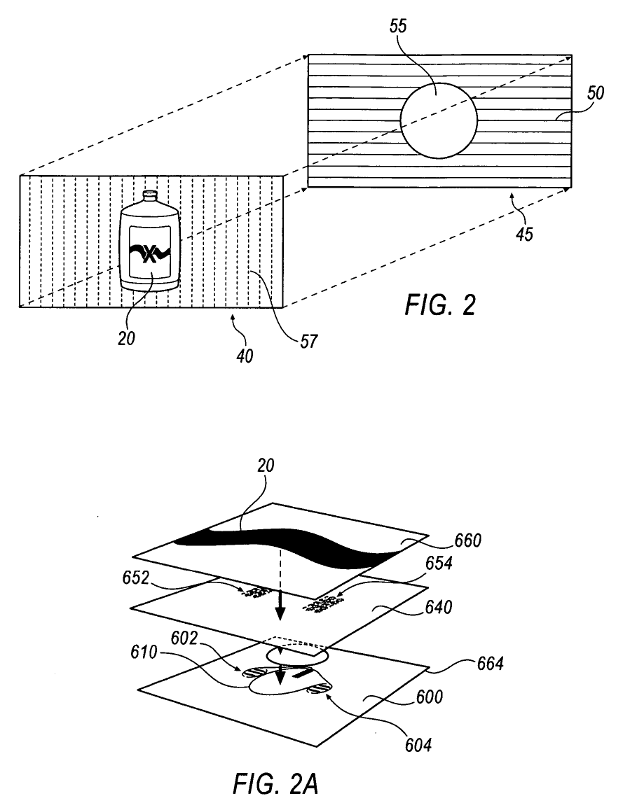

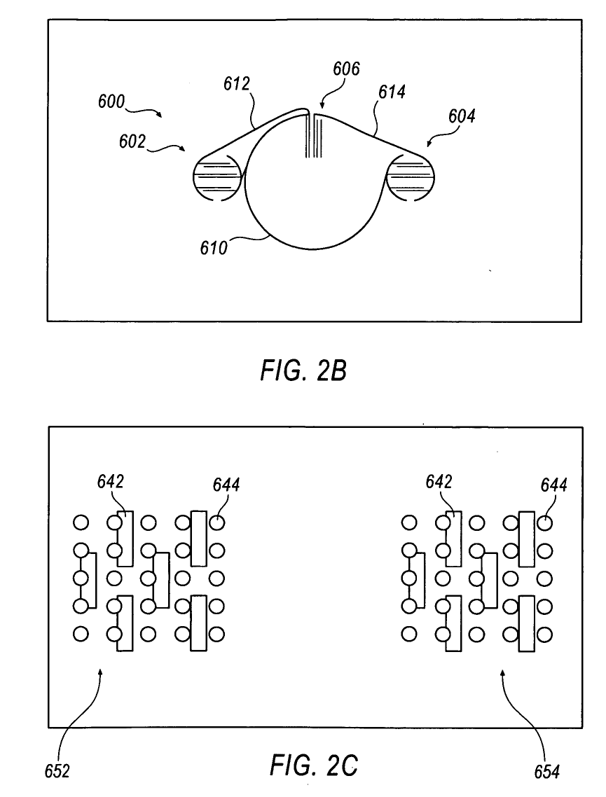

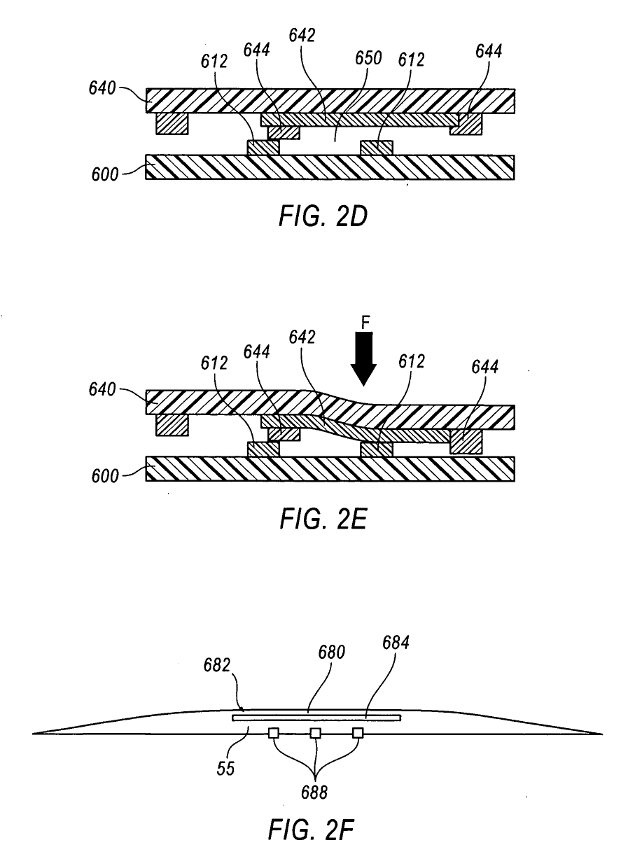

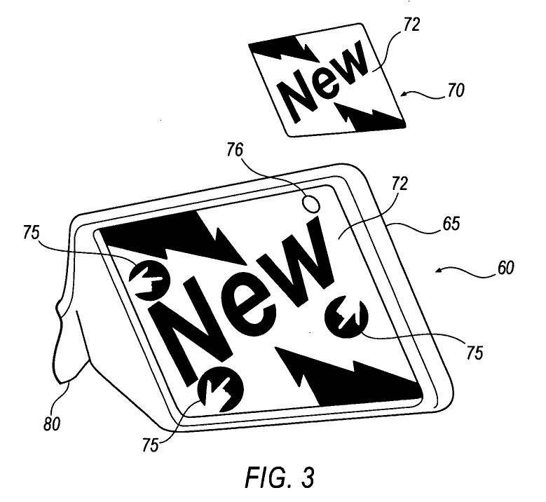

FIG. 2 shows a preferred embodiment of a floor unit like that depicted in FIG. 1. The FIG. 2 embodiment includes an overlay 40 and a circuit layer 45. The overlay 40 bears a design indicative of a product or service to be promoted. The circuit layer 45 includes a contact-activated portion 50 and a transmitter portion 55. The contact-activated portion 50 is preferably formed using conductive ink. However, the contact-activated portion could also be formed using wires. An upper contact making region 57 is preferably configured as conductive ink and patterned generally perpendicular to contact-activated portion 50. Moreover, a dielectric layer (described in detail below with respect to FIG. 2C) having openings configured therethrough separates contact making region 57 from contact-activated portion 50. When pressure is applied to contact making region 57, overlay 40 flexes and contact making region 57 comes in electrical communication with contact-activated portion 50, thereby closing and completing a circuit defined by contact-activated portion 50, contact making region 57 and transmitter portion 55. Accordingly, contact making region 57 and contact activated portion 50 functions as a switch. The portion could be entirely contact-activated, or it could be contact-activated in only selected areas. In any case, the contact-activated portion 50 is linked to the transmitter portion 55 so that the transmitter portion will generate a detection signal in response to pressure on the contact-activated areas 50. Notably, transmitter portion 55 of FIG. 2 includes and integral transmitter, whereas transmitter 35 of FIG. 1 is not integral to a circuit layer.

The use of conductive inks to form conductors and switches as discussed herein, is disclosed and described in U.S. Pat. Nos. 5,455,749 and 5,626,948, the disclosures of which are hereby incorporated by reference in their entirety

Referring back to FIG. 2, it is noted that the overlay 40 is adhered to the circuit layer 45 in either a removable or non-removable fashion. It is preferred that the overlay be adhered to the circuit layer in a non-removable fashion. The circuit layer 45 with attached overlay 40 is preferably positioned at the desired floor location and secured such that the unit will remain in place despite its operational environment. In particular, the unit should remain in place as people, shopping carts and other objects move over the unit, and in the event that fluids are spilled on or near the unit. In a preferred embodiment, the unit is secured through the use of an adhesive between the circuit layer and the floor. It is further preferred that replacement of a floor unit be effected by removing an existing circuit layer and associated overlay, and substituting a new circuit layer and associated overlay.

In the case of non-permanent attachment of the overlay to the circuit layer, a single circuit layer can be used to promote multiple products. The promotion is changed merely by replacing one overlay with another. In such a case, it should be noted that the sound and/or visual that corresponds to a particular overlay may need to be changed in order to correspond to the overlay currently in use.

In both the cases of permanent and non-permanent overlay attachment, the combined overlay and circuit layer form a floor unit in which the contact-activated area(s) are integral with the design(s).

In any event, the circuit layer 45 requires a power supply in order to carry out its detection and transmission functions. Preferably, the layer 45 is battery powered and the batteries used with the unit are expected to be effective for the same amount of time that the design shown on the floor unit is effective. For example, the floor unit is built to last 30 days, in which case the design shown on the floor unit will become marred to the point of being visually ineffective in about 30 days from its first use and the batteries used with the unit are expected to last 30 days. Thus, at the end of a unit's 30 day life it is discarded and replaced with a new unit, and there is never a need to replace the batteries of a given unit.

It should be noted that the expected battery life is dependent on the rate of activation of the floor unit. That is, the battery life will decrease as the rate of activation increases. Thus, as the activation rate increases a greater amount of battery power is needed to maintain a given battery life. Therefore, in a preferred embodiment, floor units that will experience a higher activation rate are provided with larger batteries in order to maintain a predetermined unit life.

As discussed in greater detail below, FIG. 2A depicts an exploded view of an alternative embodiment floor unit 10 in accordance with another embodiment is described. Floor unit 10 comprises a base layer 600, a dielectric layer 640, and a graphic layer 660. FIG. 2B shows an exemplary base layer 600 including a conductive ink trace layout, according to an embodiment. Base layer 600 is a portion of a contact-activated portion 50 (see also FIG. 2) and further includes a first switching area 602, a second switching area 604, and a contact area 606. First switching area 602 includes a common trace 610 and a first switch trace 612. Second switching area 604 includes common trace 610 and a second switch trace 614. Contact area 606 is configured to electrically interface with transmitter portion 55 (shown in FIG. 2) and includes separate electrical contacts for common trace 610, first switch trace 612, and second switch trace 614.

Base layer 600 typically includes an adhesive back side opposite the side shown in FIGS. 2 and 2B which includes switching areas 602, 604. The adhesive allows for an assembled floor unit 10 in the form of a mat to be placed on a floor and remain in place. In an embodiment, the adhesive is covered with a release liner, i.e., a protective disposable sheet that is removed before use. When placement of the mat is desired, the protective sheet is removed and the mat is placed on the floor. In another embodiment, the adhesive is configured for one-time user (i.e., the floor mat is disposed of after use). In yet another embodiment, the adhesive is configured to allow the floor mat to be re-positioned or moved while at the same time providing sufficient tackiness for subsequent placement. In general, the adhesive must provide a tackiness that allows for desired traffic (e.g., foot traffic, carts, and cleaning equipment) traveling over the mat without movement or pull-up.

Common trace 610, first switch trace 612, and second switch trace 614 are preferably printed on base layer 600 using conductive ink. As discussed above, examples of conductive ink printing are found in U.S. Pat. No. 5,626,948 to Ferber et al. and U.S. Pat. No. 5,455,749 to Ferber, the contents of which are incorporated by reference in their entirety.

FIG. 2C shows an exemplary dielectric layer 640 with conductive ink switch traces 642 at a first switching region 652 and a second switching region 654. Generally, first switching region 652 and second switching region 654 are configured to be directly above switching areas 602, 604 when layered. However, switching region 652, 654 may be patterned across the entirety of dielectric layer 640. Dielectric layer 640 further includes a plurality of switch traces 642 and a plurality of dielectric regions 644. Dielectric layer 640 is configured to be adhered above base layer 600 (shown in detail below with respect to FIG. 2A). Switch traces 642 are printed in conductive ink on dielectric layer 640 and are positioned upon dielectric layer 640 such that switching areas 602, 604 are substantially aligned with at least one of conductive ink contacts 642, respectively.

A plurality of dielectric regions 644 are printed upon switch traces 642 but do not cover switch traces 642 in their entirety. As a result, the exposed portions of switch traces 642 are biased away from switching areas 602 and 604, thereby providing a switching functionality when a force is applied above dielectric layer 640 (explained in detail below with respect to FIGS. 2D and 2E). Dielectric regions 644 are, in an exemplary embodiment, printed using ultraviolet cured ink.

FIG. 2D shows a cross-section view of a switching circuit in a switch open position. As shown, dielectric regions 644 do not cover switch traces 642 in their entirety. Rather, dielectric regions 644 provide a space 650 between switching areas 602, 604 and switch traces 642. In a switch open position, switch traces 642 do not touch switching areas 602, 604. Therefore, switch traces 642 do not make contact between common trace 610 and first switch trace 612 (or second switch trace 614). Thus, absent contact, switching areas 602, 604 are considered “open.” In the open position, contact area 606 shows no conduction between common trace 610 and first switch trace 612, or alternatively, common trace 610 and second switch trace 614.

FIG. 2E shows a cross-sectional view of a switching circuit in a switch closed position. Here, a force F is applied above dielectric layer 640 and mechanically forces switch trace 642 into contact with common trace 610 and first switch trace 612. The switch is “closed” where switch trace 642 electrically connects common trace 610 and first switch trace 612 of switching area 602. In the closed position, contact area 606 shows conduction between common trace 610 and first switch trace 612, or alternatively common trace 610 and second switch trace 614, depending upon where force is applied to dielectric layer 640.

As mentioned above, FIG. 2A shows an exploded view of an embodiment of floor unit 10. Floor unit 10 may be a sandwich of base layer 600, dielectric layer 640, and graphic layer 660. Graphic layer 660 is typically an advertisement message or an attention getting indicator. Moreover, graphic layer 660 may comprise a long-wearing surface such that traffic (e.g., foot traffic, carts, and cleaning equipment) may travel over floor unit 10 without damaging floor unit 10.

In an exemplary embodiment, base layer 600 is constructed of polyvinyl chloride (PVC) having an adhesive and release liner on the side which is adhered to the floor. In one especially preferred embodiment base layer 600 comprises a combined PVC/adhesive/release liner construction sold under the name Flexmount TT200-L-34460LAPFW sold by FLEXcon. Conductive ink traces, e.g., common trace 610 are printed on top of base layer 600 and are preferably selected to have the desired resistivity and may comprise a number of different conductive inks, including those described in U.S. Pat. Nos. 5,455,749 and 5,626,948. The desired resistivity of the cured metal constituent conductive ink generally ranges from about 1 milliohm/in²/mil to about 10 megaohms/in²/mil. In some applications, resistivities range from about 10 milliohm/in²/mil to about 50 milliohm/in²/mil. A resistivity of less than about 25 milliohm/in²/mil is especially preferred for a metal constituent conductive ink. In one exemplary embodiment, the conductive ink is ELECTRODAG® 976 SS HV ink supplied by Acheson Colloiden B.V. of the Netherlands. The ink may be applied by a number of printing techniques, including but not limited to screen printing, flexo printing, offset printing, gravure printing, pad printing, and transfer printing. However, when the ELECTRODAG® 976 SS HV is used, screen printing is preferred.

Although certain resistance ranges are described above, the desired resistance of a printed ink are dependent upon a number of variables including, but not limited to, the size of the layer the ink is printed on (e.g., base layer 600), the environment (e.g., high impedance or low impedance), the distance a switching circuit is located from disc 55 (e.g., distance from a sensing unit), and the material used (e.g., carbon and precious metal). Moreover, the choices regarding the type of conductive ink, and in particular the conductive constituents of the ink, depend upon costs, resisitivity and color/opacity of the conductive ink. For example, conductive ink may comprise carbon elements, graphite, conductive fibers, semi-conductive material, static dissipative material, and conductive polymers, etc. In many cases, the conductive constituent is determined based on resistivity and environment.

Other aspects of the conductive constituent may also drive the selection process. For example, dark traces for conductive ink may “show through” graphic layer 660, which is undesirable. In such a case, a clear-drying conductive ink is preferred. Otherwise, an additional production process may be required to print a white color over the traces to reduce “show through.” Alternatively, where the printed area is small, a conductive ink with a conductive constituent that dries clear may be used. Thus, a printing step is reduced and/or quality is increased. Thus, the design of the system may be driven by external or internal needs.

In another embodiment, first switch trace 612 is printed using a high-resistivity conductive ink, where switch traces 642 are printed using a low resistivity ink. Because first switch trace 612 is printed over a large area, more ink is consumed. Thus, the traces may use less expensive conductive inks and may exhibit a loop resistance (e.g., from disc 55 through first switch trace 612, switch trace 642, common trace 610, and back to disc 55) of forty (40) megaohms. If desired, the smaller switch traces 642 may be inked using a highly conductive ink.

In one embodiment, dielectric layer 640 comprises a stable sheet layer of polyethylene terephthalate (PET). As mentioned above, the conductive ink portions that make up switch traces 642 are printed directly to the bottom of dielectric layer 640 and are similarly constructed of material like that of common trace 610. As also mentioned above, the material for dielectric regions 644 printed over switch traces 642 on the bottom of dielectric layer 640. In one preferred embodiment, dielectric regions 644 are constructed of an ultraviolet light curable, non-conductive ink such as DuPont's 5018 UV curable dielectric. Graphic layer 660, also known as a wear layer, is constructed of a durable material that will adhere to dielectric layer 640. In one embodiment, graphic layer 660 comprises a FLEXMARK® V2971B frosted clear or clear film provided by FLEXcon. The graphic design may be printed on the top of wear layer 660. However, it is preferably printed on the bottom of graphic layer 660 for protection against wear. Alternatively, the graphic design may be printed on the top surface of dielectric layer 640 (i.e., on the side facing graphic layer 660).

Transmitter portion 55 houses a transmitter and other circuitry (as discussed below) and is preferably constructed of a durable, resilient material such as high density plastic. It is preferably designed to withstand a variety of weights of individuals, shopping carts, cleaning equipment, etc. and in one embodiment is rated to withstand from about 500 psi to about 1000 psi. In one embodiment, transmitter portion 55 comprises a urethane or polypropylene material. Transmitter portion 55 may also include mechanical ribs to provide further load bearing capability. Transmitter portion is preferably sized to provide an generally thin floor unit and has a radius that ranges generally from about four (4) inches to about twelve (12) inches, with radii of from about six (6) inches to about ten (10) inches being preferred. A radius of about 8 inches is especially preferred. Transmitter portion 55 preferably has a substantially flat bottom surface and a generally convex top surface that defines a central height of from about one (1) mm to about five (5) mm, with heights of from about two (2) mm to about four (4) mm being especially preferred. A transmitter portion 55 height of about two point five (2.5) mm is especially preferred.

Placed between base layer 600 and dielectric layer 640, transmitter portion 55 is configured to interface contact region 606 and electrically connect to common trace 610, first switch trace 612, and second switch trace 614. The electrical connection may be made by touching contact between contacts on transmitter portion 55, by conductive adhesive, or by a tab configuration. In an exemplary embodiment, conductive adhesive electrically connects transmitter portion 55 to contact region 606 for improved reliability. When using a tab configuration, a tab is die-cut around three sides of contact region 606 creating a hinge at the non-cut side. Thus, the tab may be flexed about the hinge. In the tab configuration, transmitter portion 55 receives the tab and makes electrical connection with common trace 610, first switch trace 612, and second switch trace 614 individually using wiping pressure contacts.

As shown in FIG. 2A, floor unit 10 is comprised of thin layers that include printed switching technology. Such a configuration allows a highly compact design allowing traffic (e.g., foot traffic, carts, and cleaning equipment) to travel over floor unit 10 without adverse implications such as tripping, stopping, or pulling-up of floor unit 10. Additionally, floor unit 10 may be configured as tapered at peripheral edges 664 such that traffic is less likely to pull peripheral edges 664 from adhesive contact with the floor. To this end, the overall thickness at peripheral edge 664 of floor unit 10, including layers 600, 640, and 660, is generally from about point two (0.2) millimeters to about point six (0.6) millimeters. In a presently preferred embodiment, the thickest portion of floor unit 10 is at the center of transmitter portion 55 and is about three point five (3.5) millimeters.

FIG. 2F shows a cross-sectional view of an embodiment of transmitter portion 55 that includes a domed upper surface 680, which is generally convex. Domed upper surface 680 provides a space 682 for a transmitter board 684 to be placed within. As discussed previously, transmitter portion 55 is, in an exemplary embodiment, constructed of a high density plastic material that withstands heavy traffic, e.g. cleaning equipment, above domed upper surface and provides that transmitter board 684 is protected from crushing. In another embodiment, transmitter portion 55 includes ribbing under domed upper surface 680 to provide additional support from crushing. Transmitter portion 55 further includes contacts that are configured to align with and electrically connect to common trace 610, first switch trace 612, and second switch trace 614 of interface contact region 606. As mentioned above, the electrical interface may be accomplished with direct contact force, conductive adhesive, or a tab configuration.

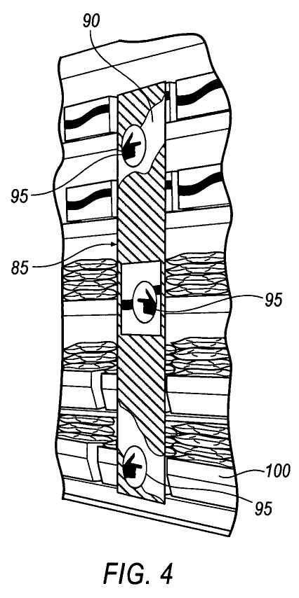

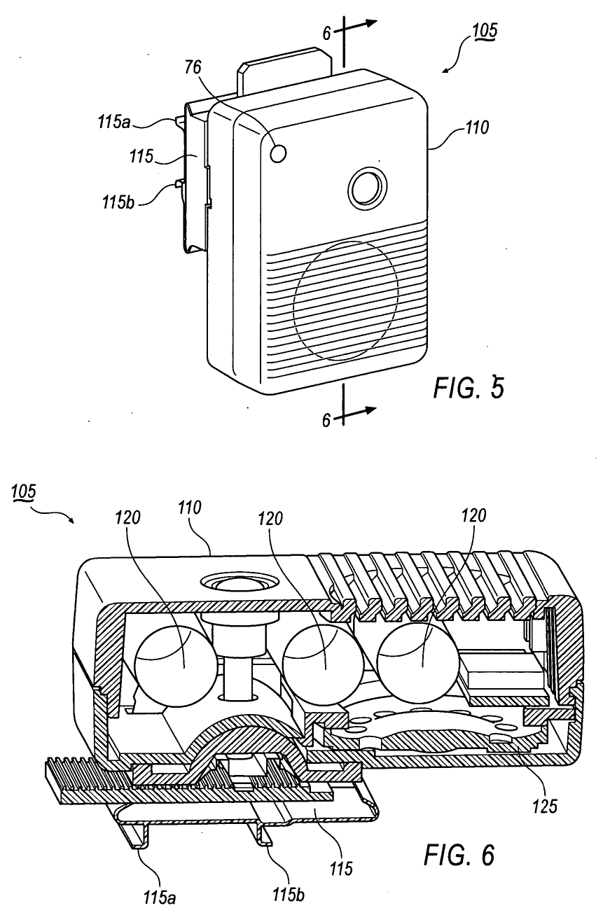

FIG. 3 shows a preferred embodiment of a communication system in which promotional sounds are communicated to persons proximal a shelf unit 60. The shelf unit 60 includes a housing 65 and a drop-in insert 70. The housing 65 secures insert 70 and houses an audio unit 66 (not visible in FIG. 3). Insert 70 bears a design 72 indicative of a product and includes a multiple of contact-activated areas 75. Audio unit 66 is housed within housing 65 and generates an audible promotional signal in response to activation of one of the contact-activated areas 75. In one embodiment, audio unit 66 is housed in a unit shaped similarly to transmitter portion 55 of the embodiment of FIG. 3. Other shapes may also be used. For example, audio unit 66 may be housed in a generally small rectangular box about the size of a typical cigarette pack. Audio unit 66 may comprise an integral part of insert 70 or may be separately disposed adjacent to it.

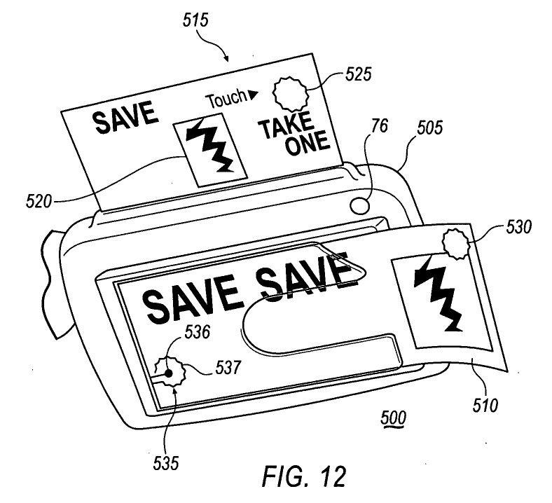

The contact-activated areas 75 of the FIG. 3 embodiment are preferably touch-sensitive switches, including the type described in U.S. Pat. No. 5,626,948. The switches are activated by the moisture present in human fingers. More specifically, when a person touches one of the areas the moisture in the person's fingers acts to trigger a switch which is electrically coupled to audio unit 66 through conductive pathways on insert 70 and/or housing 65. In this manner, when a person touches insert 70 in one of the contact-activated areas 75, a detection signal is transmitted through the insert's conductive pathways to the audio unit, either directly or through conductive pathways in the housing. Upon receiving the detection signal, audio unit 66 generates a sound. In an embodiment, the detection signal may be filtered from inadvertent triggering depending upon the environment. For example, the touch-sensitive switch may be configured such that a short circuit (e.g., zero ohms) at contact-activated area 75 may not trigger a response. This feature may be used to preserve power in the case that a metallic object (e.g., a shelf or a can) is in communication with contact-activated area 75. Moisture switches in general are discussed in greater detail below with respect to FIG. 12.

It should be noted that any conductive pathways of insert 70 are preferably formed using conductive ink in a manner similar to that described in connection with the floor unit.

The shelf unit 60 of FIG. 3 includes a shelf-attachment portion 80 for attaching the unit to a shelf such as those commonly found in retail stores. By positioning the shelf unit near the product which is the subject of the design, the shelf unit helps the buyer locate the product. Further, a curious prospective buyer can touch one of the contact-activated areas 75 if he/she wishes to hear more about the product. Thus, shelf unit can expose a buyer to both visual and audio promotion of the product at the point of sale.

Many of the optional features discussed in connection with the FIG. 1 system can be implemented in the shelf unit. Upon reading this detailed description, one skilled in the art of the invention will readily appreciate how such optional features could be incorporated into the shelf unit.

Another feature that can be included in the shelf unit 60 is a two-sided insert 70. That is, both sides of the insert 70 can have designs, and both sides can have contact-activated areas 75. A two-sided insert is visible from a wider range of positions than a one-sided insert, and is thereby more likely to attract the attention of prospective customers. Moreover, shelf unit 60 can be configured to react uniquely to each side of two-sided insert 70 having contact-activated areas 75 for each side.

In an exemplary embodiment, shelf unit 60 includes a light source 76 configured as a light emitting diode (LED). When at least one of contact-activated areas 75 is triggered, in addition to sound, shelf unit 60 may flash light source 76 to attract attention to design 72 and the location of shelf unit 60 in relation to a product. In this way, shelf unit 60 engages audio and visual senses of a potential consumer.

Additionally, where there are a plurality of shelf units 60, light source 76 on each shelf unit 60 may be configured to be triggered by a floor unit 10. By placing the plurality of shelf units 60 in a path to a product, when triggered, the plurality of shelf units 60 are able to lead a potential consumer to a product as a visible and audible pathway. In another embodiment, product packaging may include an LED and may be configured to receive transmitted signals from a floor unit 10. In this embodiment, when a customer activates floor unit 10, one or more product units will light up, thereby directing the customer to the product.

FIG. 4 shows a preferred embodiment of a communication system in which promotional sounds are communicated to persons proximal a vertical surface. The communication system may be embodied as a self-contained system that uses a generally layered construction and is attached to an object using static cling. Moreover, the communication system may be applied to walls, windows, ceilings, and display cases. In the embodiments shown in FIG. 4, the communication system is a freezer unit 85. The freezer unit 85 bears a design 90 and includes a multiple of contact-activated areas 95 and is associated with an audio unit 100. As with audio unit 66 of FIG. 3, audio unit 100 may comprise an integral part of freezer unit 85, or may be disposed separately from it, as depicted in FIG. 4. In the FIG. 4 embodiment, the freezer unit 85 is positioned on a commercial freezer of the type having glass doors and being commonly found in supermarkets. Freezer unit 85 is preferably positioned on the freezer via static cling. However, many alternative techniques of positioning freezer unit 85 on the freezer may be employed. For example, freezer unit 85 may be attached to the freezer by a mechanical means such as clamps, screws or crimping. Further, freezer unit 85 may have an adhesive backing for adhering to the freezer, may be taped to the freezer, or secured to the freezer by Velcro.

In any event, the operation of the freezer unit 85 is similar to that of the shelf unit 60. The contact-activated areas 95 are preferably touch-sensitive switches activated by the moisture in a person's finger. When a person touches one of the contact-activated areas 95, a detection signal is transmitted to the audio unit 100, and the audio unit 100 responds by producing a sound. Preferably, the contact-activated areas 95 are coupled to the audio unit 100 through conductive ink, as in the manner discussed previously.

Many of the alternative features and optional features discussed in connection with the floor system and shelf unit could be employed with the freezer unit. Upon reviewing this disclosure, one skilled in the art will readily appreciate how the various features are employed in the freezer unit.

In addition it is noted that the unit shown in FIG. 4, need not be limited to application on freezers. The unit could be employed in any location where it can be reasonably mounted. For example, the unit could be mounted on the inside of a store's window, on a wall, or on a ceiling. Thus, while a freezer application is depicted in FIG. 4, the full range of applications for the FIG. 4 unit will be apparent in light of this disclosure.

Having provided a description of floor, shelf and freezer embodiments, the electronics of the floor system will be discussed in more detail. Notably, the audio units employed in the floor, shelf and freezer embodiments share many of the same elements. Accordingly, in the following detailed discussion of the floor system audio unit, the use of the unit in the shelf and freezer embodiments is also addressed. Moreover, the audio functionality of audio units may be built into shelf unit 60 of FIG. 3 as well as coupon unit 500 of FIG. 12. Moreover, for example, freezer unit 85 may be configured to receive an audio unit that is hard-wired.

FIG. 5 shows an audio unit 105 suitable for use with the FIG. 1 embodiment. The unit includes a housing 110 and a shelf attaching portion 115. The shelf attaching portion has two protruding portions 115a and 115b which are designed to mate with corresponding groove portions (e.g. price channel) on the shelf of a retail store. Moreover, audio unit 105 may also include a light source 76 (discussed in detail above with respect to FIG. 3).

FIG. 6 shows a cross-section of the audio unit 105 of FIG. 5. As can be seen from FIG. 6, the unit includes space for three batteries 120 (e.g. “AA” size) and a speaker 125 for producing an audible signal. The use of three “AA” batteries to supply power to the unit is merely illustrative. Many power supply configurations are suitable for use in the invention. For instance, the number of batteries could be more or less than three, the class of batteries used could be other than “AA,” or power could be supplied through an alternating current (AC) power line.

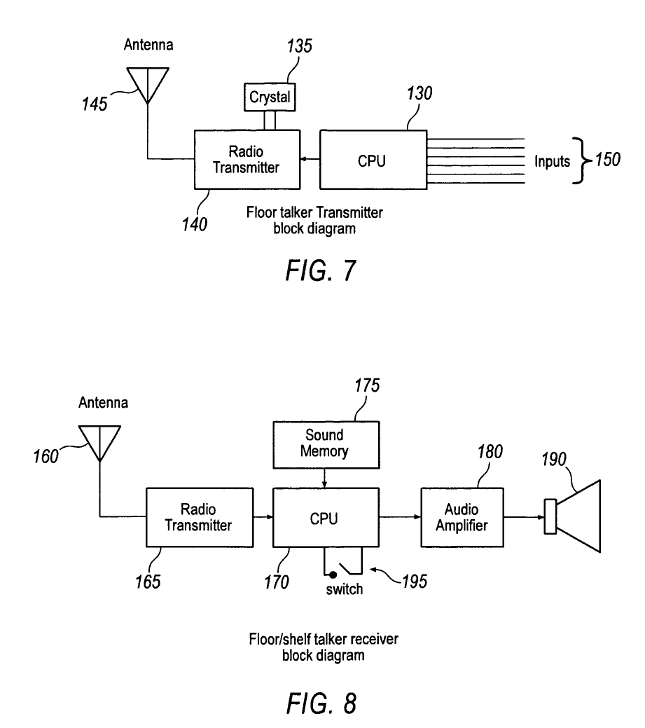

The electronics of the audio unit are discussed in more detail in connection with FIGS. 7-10.

FIG. 7 is a block diagram of the transmitter portion of the circuit layer depicted in FIG. 2. As can be seen from FIG. 7, the transmitter includes a central processing unit (CPU) 130, a crystal oscillator 135, a radio transmitter 140 and an antenna 145. The CPU receives one or more detection signals on inputs 150. More specifically, when a person steps on one of the contact-activated areas shown in FIG. 1, a logic level detection signal is transmitted to the CPU via one or more of inputs 150. In response to receiving a detection signal, the CPU sends a transmit indication to radio transmitter 140. In response to receiving the transmit indication, the transmitter 140 transmits a predetermined signal via antenna 145. The predetermined signal is an RF signal that is transmitted on a carrier frequency derived form crystal oscillator 135.

In an alternative embodiment, radio transmitter 140, crystal oscillator 135 and antenna 145 can be replaced by an IR transmitter. In such a configuration, the CPU sends a transmit indication to the IR transmitter in response to a detection signal on one or more of inputs 150.

FIG. 8 is a block diagram of an audio unit such as audio unit 105 of FIGS. 5 and 6. The audio unit includes an antenna 160, a radio receiver 165, a CPU 170, a sound memory 175, an audio amplifier 180 and a speaker 190. Antenna 160 is operable to receive RF signals from a transmitter. For example, antenna 160 is operable to receive predetermined RF signals such as those generated by the transmitter 140 depicted in FIG. 7.

An RF signal received through antenna 160 is coupled to the radio receiver 165. The receiver 165 demodulates the signal and passes the demodulated signal to CPU 170. Upon receiving the demodulated signal CPU 170 retrieves a stored audio signal from sound memory 175 and reproduces the audio signal. The reproduced signal is amplified by audio amplifier 180 and converted to a sound by speaker 190.

In the preferred embodiment, sound memory 175 is an integrated circuit memory and the audio signal is prerecorded in the memory in digital form. However, sound memory 175 may take many alternative forms. For example, the audio signal may be stored on an optical disc, in which cases the audio unit includes an optical disc reading device (not shown). Further, the audio signal may be stored on a tape, in which cases the audio unit includes a tape reading device (not shown).

In any event, as an optional feature sound memory 175 can store a multiple of audio signals. If multiple audio signals are stored, sound generated by the audio unit can be varied.

Referring to FIGS. 7 and 8, it can be seen that when a detection signal appears on one or more of inputs 150, a predetermined signal is transmitted from antenna 145 to antenna 160 and triggers generation of a sound from speaker 190. In this manner, the transmitter of FIG. 7 and audio unit of FIG. 8 are employed in the floor based system, with the transmitter of FIG. 7 provided in transmitter portion 55 of FIG. 2, and the audio unit of FIG. 8 provided in audio unit 15 of FIG. 1.

It is also possible for the audio unit of FIG. 8 to be employed in the shelf unit 60 and freezer unit 85. In the shelf and freezer unit embodiments, audio units may be directly connected, in which case antenna 160 and radio receiver 165 of FIG. 8 are not needed. Instead, a switch 195 is employed. Switch 195 is activated in response to a detection signal generated by the contact-activated areas of the shelf or freezer unit. When switch 195 is activated, the CPU retrieves the audio signal from sound memory and reproduces the audio signal. The reproduced signal is amplified by the audio amplifier and made audible by the speaker. Of course “activation” of switch 195 could mean that switch 195 is closed in response to a detection signal, or alternatively, that switch 195 is opened in response to a detection signal. Generation of sound in response to opening or closing of switch 195 is a design choice.

Preferably, conductive ink is used in the shelf and freezer embodiments to couple the contact-activated areas to switch 195. For example, in the freezer unit of FIG. 4, when one of contact-activated areas 95 is touched the touching is electrically communicated between the touched area and audio unit 100 via conductive ink. The communication causes switch 195 to activate and initiate generation of a sound.

It should be noted that antenna 160 and radio receiver 165 may be included in the shelf and freezer audio units even if they are not used in such units.

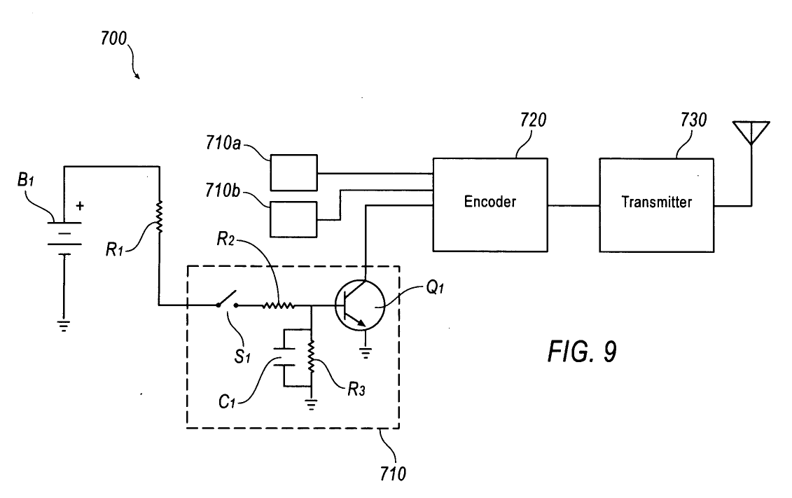

FIG. 9 is a diagram of a preferred embodiment of a transmitter circuit 700 including transmitter board 684, common trace 610, and first switch trace 612. Transmitter circuit 700 corresponds with the block diagram of FIG. 7. Transmitter circuit 700 includes a battery B1, an input resistor R1, a switching circuit 710, a switch S1, an interface resistor R2, a pull-down resistor R3, a capacitor C1, a transistor Q1, an encoder 720, and a transmitter 730.

The contact-activated areas 25 of floor unit 10, e.g. switching areas 602 and 604, are each represented by a corresponding switch S1, only one of which is shown in FIG. 9. In a preferred embodiment, the switches S1 are effectively coupled to encoder 720 by transistors Q1, and activation of any of the contact-activated areas 25 of floor unit 10 are reflected at their respective transistor Q1.

Battery B1 comprises a plurality of thin batteries housed within transmitter portion 55, in an exemplary embodiment. For improved life-span of floor unit 10, the plurality of batteries comprising battery B1 are connected in parallel. In order to reduce the overall thickness of transmitter portion 55, and of floor unit 10, battery B1 is comprised of coin-cell type batteries. An alternative method of powering transmitter circuit 700 includes replacing battery B1 with a direct-wire power source such as a power regulator operating from typical one hundred twenty (120) volt alternating current systems, or its equivalent.

Resistors R1, R2, and R3 are used to provide a preferred voltage to the base of transistor Q1 when switch S1 is closed. Depending upon the conductive inking technology used for switch S1, the resistances may be adjusted accordingly. For example, where a carbon-based conductive ink is used, resistors R1, R2, and R3 may be in the range of from about 50K ohms to about 200k ohms, including a preferred embodiment having a resistance of about 100k ohms. Where silver-based conductive ink technology is used, resistors R1, R2, and R3 may be in the range of about 200K ohms to about 400k ohms, including a preferred embodiment having a resistance of about 330k ohms. Moreover, the resistance of input resistor R1 may be adjusted depending upon the environment encountered by floor unit 10. Indeed, where a high impedance environment is encountered, e.g. a closed dry area, input resistor R1 may be configured as a lower value such as about 50k ohms. Where floor unit 10 is placed in a low impedance environment, e.g. a damp area, input resistor R1 may be configured as a higher value, such as about 500k ohms. Although reference ranges are provided herein by way of example, input resistor R1 may range from zero (0) ohms to about two thousand (2000) megaohms depending upon the operating environment of floor unit 10. Input resistor R1 is primarily dependent upon the substrate material properties that the switching circuit is printed upon (e.g., base layer 600). In a preferred embodiment using polyethylene terephthalate (PET) as a substrate material, input resistor R1 is about sixty five (65) megaohms. In a preferred embodiment using a paper-based substrate material, input resistor R1 is about twenty (20) megaohms. Of course, the resistance of input resistor R1 may be tuned for the particular properties of a desired substrate material.

Pull-down resistor R3 and capacitor C1 provide a switch delay/debounce function. When switch S1 is closed, capacitor Cl will charge by way of the current flowing through switch S1 and resistor R2. If switch S1 is closed for only a short period of time, capacitor Cl will not charge to a level that will allow the base of transistor Q1 to turn on. Thus, for brief momentary contact, pull-down resistor R3 and capacitor C1 function to avoid false-triggering of transmitter circuit 700. Moreover, debouncing switch S1 conserves battery life in that encoder 720 and transmitter 730 are not drawing operating-level power, but rather only drawing quiescent current from battery B1. The debouncing of switch S1 prevents false triggering due to minor vibrations or incidental contact with floor unit 10. However, where switch S1 is closed for a longer period of time capacitor C1 will charge to a level that switches on transistor Q1.

Transistor Q1, when conducting, is used to signal to encoder 720 that a switch has been closed. Encoder 720 provides transmitter 730 with a unique code that indicates which particular switch or switches S1 are closed. In addition to switching circuit 710, transmitter circuit 700 may include a plurality of switching circuits 710a, 710b that interface with other switch traces of base layer 600, e.g., second switch trace 614. In this way, transmitter circuit 700 is able to read more than one switch of floor unit 10 and transmit which switch was activated to a receiver 800 (described below in detail with respect to FIG. 9). Encoder 720 provides that the status of each switch closed is sent via transmitter 730. This configuration allows different switches to trigger different corresponding sonic or visual displays or indications.

In a preferred embodiment, transmitter 730 uses radio-frequency transmissions to communicate with receiver 800. However, transmitter 730 may be configured in any manner to communicate with receiver 800. Examples of communication paths from transmitter 730 to receiver 800 may include, but is not limited to, radio-frequency, infrared, Bluetooth, ultrasonic, microwave, ZigBee, direct wire methods, or combinations thereof.

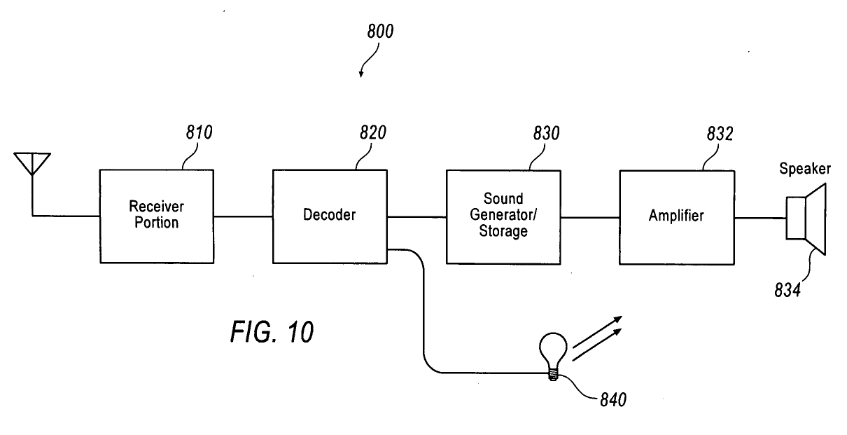

FIG. 10 is a diagram of a preferred embodiment of a receiver unit 800 and the audio unit 105 depicted in FIG. 5. Receiver unit 800 includes a receiving portion 810, a decoder 820, a sound generator 830, an amplifier 832, a speaker 834, and a light 840. Receiving portion 810 receives signals sent from transmitter 730 and generates logic level signals based upon the received information. Decoder 820 converts the received signal from receiving portion 810 and outputs signals to sound generator 830 and/or light 840.

Light 840 provides visual cues provided by a light source. In an exemplary embodiment, light 840 is a light emitting diode (LED). Moreover, receiver 830 may include a plurality of lights 840 that may be triggered individually or together based upon the signal received from transmitter 730. Further, light 840 may be used as a visual indicator or queue to catch the attention of a user or potential customer. Light 840 may also be used to lead a customer to a particular location directly, or in combination with other receivers 800 to signal a path to a location. In this way, a potential customer may trigger transmitter 730 and be led by a single receiver 800 or a plurality of receivers 800 to a particular location.

Sound generator 830 receives signals from decoder 820 to provide prerecorded sounds or voice messages based upon which inputs were triggered at floor unit 10. Sound generator 830 may include storage for prerecorded sounds or an external storage device may provide the sounds. Amplifier 832 takes an audio signal from sound generator 830 and increases the signal's power so as to drive speaker 834. Speaker 834 is used as the sound generating device.

The embodiment depicted in FIG. 10 differs from that depicted in the block diagram of FIG. 8 in that the FIG. 10 embodiment includes a signal decoder 820 between receiving portion 810 and sound generator 830 and light 840. In operation, a signal received through an antenna is coupled to receiving portion 810. Receiving portion 810 demodulates the signal and passes the demodulated signal to decoder 820. Decoder 820 decodes the demodulated signal and outputs a signal, or signals, based upon the received signal that includes encoded information. For example, where floor unit 10 includes a plurality of switching regions, the transmitter may encode which switch or switches have been triggered. Thus, decoder 820 produces signals that indicate at receiver 800 which switching regions were pressed. In an embodiment, a first switch may trigger a sound from speaker 834 and a second switch may trigger light 840 to activate.

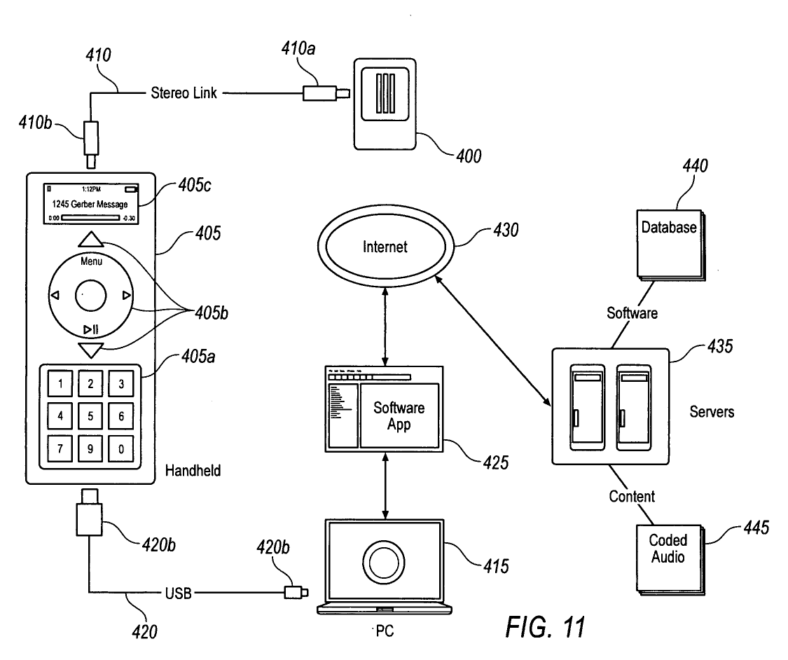

In one embodiment, the audio messages generated by audio units 66, 100, or 105 may be remotely updated by a user. FIG. 11 is a diagram depicting an exemplary scheme for updating messages stored in an audio unit such as those described previously. In the figure, an audio unit 400 is updated by a handheld updater 405. The audio unit is coupled to the updater by a stereo link 410, which includes stereo-type connectors 410a and 410b. Connector 410a mates with a corresponding receptacle on audio unit 400 and connector 410b mates with a corresponding receptacle on updater 405. By way of the stereo link, audio signals are transferred from updater 405 to the sound memory of audio unit 400. Preferably, the audio signals are stored in updater 405 in digital form and are transferred in digital form to the memory of audio unit 400.

In a notable alternative embodiment, the link between updater 405 and audio unit 400 is a wireless link.

The updater includes a numeric keyboard 405a, a multiple of touch-sensitive areas 405b, and a display 405c. The keyboard 405a and touch sensitive areas 405b are used to control the device by entering instructions or by selecting items on a displayed menu. The display 405c presents menus to a user as well as indicates the status of an operation. For example, the display 405c offers the user a multiple of audio signals for download to audio unit 400, and the user selects a signal for download using one of the touch-sensitive areas 405b. Upon selection of a signal, the display 405c shows the signal selected along with an indication of time remaining to complete the download.

Preferably, updater 405 is battery powered, and the display 405c shows an indication of time remaining before the battery, or batteries, will no longer effectively power the device.

The audio signals stored in updater 405 are uploaded from a personal computer (PC) 415 via a universal serial bus (USB) link 420. The USB link 420 is coupled to updater 405 and PC 415 through USB connectors 420a and 420b. Uploading is controlled through a software application 425 running on the PC 415. The software application is preferably a windows-based application that is capable of opening an Internet connection 430 for purposes of accessing one or more server computers 435. The servers 435 have access to a database of audio signals 445 in the form of, for instance, coded digital audio. Thus, the PC 415 can download additional audio signals by accessing database 445 through the internet and server computers 435.

In addition, the software application can be used to download software updates from a database 440.

The system depicted in FIG. 11 allows for efficient updating of the audio signals reproduced by the audio units associated with floor, shelf and freezer units located throughout a store. For example, a new set of audio signals can be downloaded daily from the Internet 430 to the PC 415 and, in turn, to updater 405. A store employee could then walk around the store with updater 405 and update the audio signal(s) associated with each audio unit in the store. In this fashion, the audio signal associated with a given promotion can be changed on a daily basis with relative ease.

Regarding the updating feature of the invention, reference is made to U.S. Pat. No. 6,253,183. Upon reviewing the disclosure of U.S. Pat. No. 6,253,183 patent in view of the present disclosure, one skilled in the art can readily implement the subject matter of U.S. Pat. No. 6,253,183 within the present invention. U.S. Pat. No. 6,253,183 is hereby incorporated by reference.

FIG. 12 shows a preferred embodiment of a communication system in which promotional messages are communicated to persons proximal a coupon unit 500. The coupon unit includes a housing 505 for holding coupons 510 and a drop-in insert 515. The drop-in insert 515 bears a design 520 and includes a detection area 525. The housing unit 505 contains an audio unit (not shown) like that contained in the shelf unit 60 of FIG. 3.

Each of coupons 510 is formed with a trigger area 530 having a resistance in a predetermined range. When the trigger area is placed against detection area 525, coupon unit 500 generates a sound associated with design 520. More specifically, detection area 525 generates a detection signal when an object having the predetermined resistance is placed against detection area 525 and the detection signal is relayed to an audio unit to initiate production of a sound associated with design 520. In order to prevent false triggering, of the coupon is formed to have a relatively uncommon resistance value. Most preferably, the resistance value of trigger area 530 is about 1 k-ohm. In the preferred embodiment, the coupling of trigger area 530 to the audio unit includes conductive ink. Detection area 525 is formed of multiple electrodes as is described below with respect to touch-sensitive area 535.

In an alternative embodiment, detection area 525 communicates with a controller that has the ability to measure a wide range of resistances of objects in contact with detection area 525. When resistance values are determined as, for example, one (1) kilo-ohm for a first coupon 510, and five (5) kilo-ohms for a second coupon 510, coupon unit 500 is able to produce sounds or messages that are separately relevant to each coupon. Moreover, coupon unit 500 may distinguish between a coupon 510 and a person's finger and provide an individualized message for each detection.

Many of the optional features discussed in connection with the systems of FIGS. 1, 3 and 4 can be implemented in the coupon unit. Upon reading this detailed description, one skilled in the art will readily appreciate how such optional features could be incorporated into the coupon unit.

As an additional feature, a touch-sensitive area 535 is included on the coupon unit. The touch-sensitive area 535 functions like the touch-sensitive areas of the shelf unit. It is activated by the moisture in a person's finger. When the area is touched, it generates a detection signal which, in turn, initiates generation of a sound associated with design 520. Preferably, area 535 is transparent. Touch-sensitive area 535 includes a first electrode 536 and a second electrode 537. When touched, a controller (not shown) within housing 505 measures the resistance between first electrode 536 and second electrode 537 to determine whether moisture from a person's finger is being measured. Depending upon ambient temperatures, humidity, and the condition of the person's skin, the measured resistance may be in the range of approximately five hundred (500) kilo-ohms to approximately two (2) megaohms.

It is noted that coupons which activate the coupon unit to generate a sound do not need to be distributed through the unit. That is, a person could trigger the coupon unit with any coupon having an appropriate trigger area, no matter where the person acquired the coupon. For example, coupon dispensers could be placed at the front of a store where shoppers could obtain the coupons for use at coupon units located throughout the store. In one such embodiment, a first coupon relating to a product and having a trigger area 530 could be dispensed at the front of a store, and when the first coupon is placed against detection area 525 of a coupon unit located near the product a second coupon is issued. Thus, in the process of acquiring the second coupon, the person is exposed to a promotional sound or visual about product at a time when the person is proximal the product.

In other embodiments, coupons including trigger area 530 may be delivered to potential consumers via direct mail, magazine inserts, or otherwise provided. Retailers may then provide coupon unit 500 at a store that plays a message indicating a savings number to a potential consumer when the coupon is placed in contact with detection area 525. Moreover, prize-based games may be performed wherein a coupon encoded with an appropriate resistance value at trigger area 530 may be redeemable for a prize. In this case, a consumer would travel to a store and test the coupon using coupon unit 500 to see if the coupon were a winning coupon. If the coupon were encoded as a winning ticket, coupon unit 500 would indicate the winning nature of the ticket, a prize or savings value, and instructions for redemption.

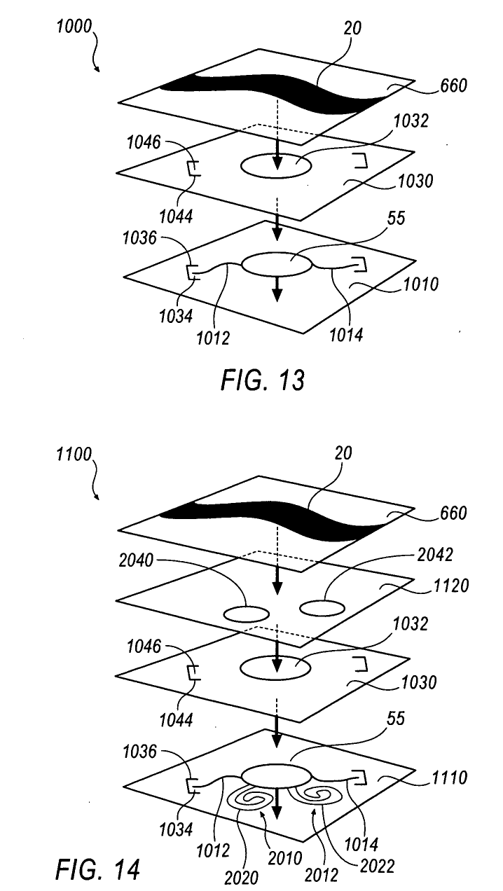

FIG. 13 illustrates an alternative embodiment of floor unit 10 that is a piezo-based floor unit 1000. Piezo-based floor unit 1000 includes a base layer 1010, a disc 55, a piezo layer 1030 having a cut-out 1032, and a wear layer 660.

Base layer 1010 is preferably comprised of the same material as base layer of FIG. 2A. Printed upon base layer 1010 are sensing traces 1012, 1014 that are printed of conductive ink similar to the traces of 610 and 612 of FIG. 2B. However, as shown in FIG. 13, sensing traces 1012, 1014 are not functioning as a mechanical switch, but rather, are used to detect voltage changes in piezo layer 1030.

Piezo layer 1030 is a sheet, or film, preferably comprising polarized fluoropolymer or polyvinylidene fluoride (PVDF). In a preferred embodiment, piezo layer 1030 is a film material having a thickness of about point five (0.5) millimeters. One suitable PVDF sheet material is the Kynar brand by Pennwalt Corp. of Valley Forge, Pa., type LDT1-028K. Given the thinness of piezo layer 1030, the cross-sectional area is very small. Thus, when compressed in the direction of its thickness dimension, a substantial stress is created within the material. This stress generates significant and measurable voltages (e.g., from about two (2) to about fifteen (15) volts). Sensitivity of piezo layer 1030 depends primarily on the composition of the piezo material as well as the thickness (or thinness) or the layer.

Cut-out 1032 is a die cut circle slightly larger than disc 55. Thus, when assembled, piezo layer 1030 will lie around, but not above, disc 55. In this way, piezo layer 1030 is protected from excessive pressure that would otherwise be applied between traffic over floor unit 10 and disc 55.

Disc 55 is similar to the disc described herein, but in this embodiment, further includes the ability to detect a voltage between sensing traces 1012, 1014. Such a detection may be accomplished via an analog to digital converter (ADC) or a comparator configured to be triggered above or below a predetermined voltage level. Moreover, a delay or debounce function can be implemented in software of a microcontroller housed within disc 55 by reading the analog to digital converter. The thresholds, detected using either an analog to digital converter or a comparator, provide a minimum threshold of force presented and necessarily voltage generated to trigger disc 55 into taking an action (such as transmitting a signal). Thus, piezo layer 1030 and the hardware and software of disc 55 may be configured such that piezo layer 1030 behaves in the same manner as a mechanical switch (e.g., on and off vs. analog voltage level). When a comparator is used for sensing detection of piezo-based floor unit 1000, the system behaves similarly to a switch due to the hardware threshold, yet does not require an electromechanical device. When an ADC is used, software may be programmed to provide a virtually unlimited variety of behaviors.

In comparison to switching areas 602, 604 (see FIG. 2A), piezo-based floor unit 1000 does not use an electro-mechanical switching mechanism, but rather, disk 55 detects a voltage generated by piezo layer 1030 to determine whether a load (e.g., customer traffic or objects) is present upon piezo-based floor unit 1000. In a preferred embodiment, piezo layer 1030 generates between about two (2) and about fifteen (15) volts from approximately about ten (10) to about four hundred (400) pounds placed upon piezo-based floor unit 1000. Because piezo layer 1030 provides a voltage based upon applied pressure, disc 55 is able to determine the difference, for example, between a light object and a heavy object (e.g., a child and an adult). Moreover, the voltage response of piezo layer 1030 is also dependent upon the speed of force application. Thus, by sensing the generated voltage, disc 55 is able to distinguish a light or heavy object and how fast they have moved across piezo-based floor unit 1000. In this way, sensing is improved over the mechanical switching applications and disk 55 and any receiving units (e.g., audio unit 105) are able to perform more complex tasks based on improved information. In one exemplary embodiment, the particular message generated by an audio unit can be tailored to the specific load, allowing different messages to be provided, for example, to adults and children.

Wear layer 660 is a durable material that will adhere to dielectric layer 640. In one embodiment, graphic layer 660 comprises a FLEXMARK® V2971B frosted clear or clear film provided by FLEXcon. The graphic design may be printed on the top of wear layer 660. However, it is preferably printed on the bottom of graphic layer 660 for protection against wear. Alternatively, the graphic design may be printed on the top surface of dielectric layer 640 (i.e., on the side facing graphic layer 660).

Voltage is generated by piezo layer 1030 when a force is applied from above. Sensing traces 1012, 1014 connect with disc 55 and provide a circuit path for voltage developed by piezo layer 1030 to be measured by disc 55. In an exemplary embodiment, sensing traces 1012, 1014 comprise conductive inks and are electrically connected to piezo layer 1030 using a fold-over tab method. Fold-over tabs include a first tab 1034, a first cut-out 1036, a second tab 1044, and a second cut out 1046. First and second cut-outs 1036, 1046 are die cut into layers 1010 and 1030 as three-sided shapes. Thus, first and second tabs 1034, 1044 are bendable from their respective layers 1010 and 1030. To electrically connect, for example, piezo layer 1030 at the location of second tab 1046 with sensing trace 1012 at the location of first tab 1034, second tab 1046 is folded with first tab 1036 under base layer 1010. In this way, an electromechanical connection is made by way of the contacting fold. In an alternative embodiment, a conductive adhesive may be used to connect sensing trace 1012 to piezo layer 1030. In yet another alternative embodiment, the compression of the structure of piezo-based floor unit 1000 provides for an electrical connection therebetween.

Alternative embodiments of piezo-based floor unit 1000 include a plurality of separate portions of piezo material that each independently generate voltage when stepped upon. In this case, multiple sensing traces 1012, 1014 are routed to each separate portion such that disc 55 is able to detect which portion has been triggered. This embodiment provides a plurality of contact-activated areas while reducing the amount of piezo material required.

In yet another alternative embodiment, piezo layer 1030 may be used as a sound producing element (e.g., a speaker). Where the inputs of disc 55 are changed to outputs (either in hardware based on a sensed switch event or in software), current may be passed through piezo layer 1030 to generate motion. Instead of transmitting a signal to an audio unit 105 (see FIG. 6), in this alternative embodiment disc 55 uses piezo floor unit 1000 as the speaker itself. Moreover, disc 55 may function to trigger audio unit 105 when a certain portion of piezo floor unit 1000 is stepped on, while using piezo floor unit 1000 as a speaker when other portions of piezo floor unit 1000 are stepped on. Thus, disc 55 determines which output to trigger based upon location of force applied. In an alternative embodiment, disc 55 may selectively trigger sound, or light generating devices based on the magnitude of the force applied.

Communication systems such as those described herein may also include the ability to change colors upon detecting the presence of a person or object proximate a design. FIG. 14 illustrates one such embodiment of a thermochromic floor unit 1100 that has the ability to change color. Thermochromic floor unit 1100 includes a base layer 1110, a disc 55, a piezo layer 1030 having a cut-out 1032, a thermochromic layer 1120, and a wear layer 660.

Base layer 1010 is preferably comprised of the same material as base layer of FIG. 2A. Printed upon base layer 1010 are sensing traces 1012, 1014 that are printed of conductive ink similar to the traces of 610 and 612 of FIG. 2B. Sensing traces 1012, 1014 are configured similarly to those shown in FIG. 13 and are used by disk 55 to detect voltage changes in piezo layer 1030.

Piezo layer 1030 is preferably a sheet, or film, of polarized fluoropolymer or polyvinylidene fluoride (PVDF). The properties of piezo layer 1030 are similar to that FIG. 13. Moreover, the function of piezo layer 1030 and the interaction with disc 55 and base layer 1110 are similar. Wear layer 660 is a durable material that will adhere to dielectric layer 640 and is similar to that of FIG. 13. A graphic design may be printed on the top of wear layer 660. However, it is preferably printed on the bottom of graphic layer 660 for protection against wear. Alternatively, the graphic design may be printed on the top surface of thermochromic layer 1120 (i.e., on the surface facing wear layer 660).

Thermochromic layer 1120 provides a medium for printing of graphics and of thermochromics, including a first thermochromic region 2040, and a second thermochromic region 2042. Each thermochromic region 2040, 2042 allows disc 55 to control the color in the respective region. That is to say, disc 55 can selectively change the color of thermochromic regions 2040, 2042. Thermochromic materials are compositions, typically dispersed within a resin along with a conductive material, that changes color when heated. Such compositions and systems of manufacturing thermochromic systems are found in U.S. Pat. No. 6,188,506, which is hereby incorporated by reference in its entirety.

A first heating element 2010 and second heating element 2012 are printed on base layer 1110 using conductive ink. In one embodiment, first heating trace 2020, and second heating trace 2022 are conductive ink traces that carry current switched by disc 55. In an exemplary embodiment, disc 55 may detect the presence of a person standing upon thermochromic floor unit 1100 and can then change the color of the region the person is standing on to get their attention.

In operation disc 55 switches current from a battery through heating trace 2020 using a transistor. The current flowing therethrough heats the area immediately surrounding it, including piezo layer 1030 and thermochromic layer 1120. However, due to the construction and thermal conductivity of the layers 1110, 1030, 1120, the majority of heat is transmitted upward through the layers 1030 and 1120 rather than laterally across the layers. Thus, where thermochromic regions 2040, 2042 are substantially aligned with first heating element 2010 and second heating element 2012, respectively, the majority of heat is transferred through the layers to activate the color-changing features of thermochromic regions 2040, 2042.

In practice, thermochromic layer 1120 may also be applied to the electromechanical switching techniques of FIG. 2A. Moreover, each thermochromic region 2040, 2042 may be triggered independently or together. Additionally, when using piezo layer 1030, thermochromic regions 2040, 2042 may be triggered based on a weight and/or speed of an object moving over Thermochromic floor unit 1100.

Modifications to the present invention would be obvious to those of ordinary skill in the art in view of this disclosure. For instance, the floor unit of FIG. 1 can be used to initiate a sound from the audio units of the FIG. 3, FIG. 4 and/or FIG. 12 embodiments. Similarly, each of the shelf unit, freezer unit and coupon unit can trigger one or more of the other units.

Various methods of using the communications systems described herein can be used to promote a wide variety of products and services. In one such embodiment, an audio unit of the type describe herein could be positioned on a shopping cart. A customer then steps on or rolls his or her cart on one or more contact activated areas 25 of a floor mat 10, as depicted in FIG. 1. In such an embodiment, when a sensor (e.g. first switching area 602 and/or second switching area 604) detects the cart in proximity to a particular product, the sensor generates a detection signal which causes a transmission to the cart's audio unit (e.g., audio unit 105 of FIG. 5). Upon receiving the transmission, the cart's audio unit generates a sound related to the product. For example, a floor unit 10 associated with a product detects the presence of a cart via a contact-activated area 25 and transmits a signal to the cart's audio unit 105 in response to the detection. The cart's audio unit then generates a sound associated with the product. In one implementation, the transmission sent to the cart's audio unit 105 is modulated for purposes of identifying the sound that is to be generated. That is, each product is associated with a unique modulation so that upon reception of a transmission the cart's audio unit can determine the modulation, cross-reference the modulation to the desired product sound, and generate the desired sound. In this manner, the sound generated by the audio unit corresponds to the product associated with the sensor that detects the cart's presence.

In accordance with another embodiment of a method of using a communication system, a plurality of floor mats 10 each having different graphics may be provided in proximity to one another in a given location, for example, in an automotive dealership. Each floor mat 10 may have a graphic design 20 associated with a different vehicle. When a potential customer steps on a contact activated area 25 associated with the floor mat 10 for a given vehicle model, an audio message is generated which provides information about the vehicle and/or directs the customer to units of the vehicle in the showroom. In a further embodiment, a plurality of receiver circuits each having LEDs may be provided wherein the LEDs are configured to define a path to the particular vehicle, thereby leading the potential customer to it. As is readily apparent, this method could also be used in retail outlets, grocery stores, and in non-commercial environments where it is desirable to direct a person to a particular location.

As these and other variations and combinations of the features discussed above can be utilized without departing from the present invention as defined by the claims, the foregoing description of the preferred embodiments should be taken by way of illustration rather than by way of limitation of the invention as defined by the claims.

What is claimed is:

1. A communication system, comprising:
a floor unit comprising a design concerning a subject; and
a message device, wherein when the floor unit detects the presence of at least one person or object proximal the design, the message device generates a message related to said subject.

2. The communication system of claim 1, wherein said design is an advertisement and said message is an audible promotional message.

3. The communication system of claim 1, wherein the floor unit is a layered unit comprising a circuit layer and an overlay bearing the design.

4. The communication system of claim 1, wherein the floor unit is a layered unit comprising a piezoelectric layer and an overlay bearing the design.

5. The communication system of claim 4, wherein the floor unit comprises a piezoelectric layer having the design printed thereon.

6. The communication system of claim 1, further comprising a thermochromic material, wherein when the floor unit detects the presence of at least one person or object, the thermochromic material changes color.

7. The communication system of claim 4, wherein the floor unit comprises a sensor, and the sensor is integral to the circuit layer.

8. The communication system of claim 7, wherein when the sensor detects the presence of one or more persons or objects proximal the design, the sensor transmits a detection signal to the message device to initiate generation of the message concerning the subject.

9. The communication system of claim 7, wherein the sensor is a contact-activated sensor.

10. The communication system of claim 7, wherein the sensor comprises conductive ink.

11. The communication system of claim 1, wherein the message can be changed through the use of a updater.

12. The communication system of claim 1, wherein when a person or object is detected while a first message is being generated, the first message is not interrupted.

13. The communication system of claim 1, wherein when a person or object is detected and generation of a message is initiated, the system is rendered non-responsive for a period of time following completion of the message.

14. The communication system of claim 1, wherein the design comprises a plurality of designs each corresponding to a subject, and when the floor unit detects the presence of a person or object proximate one of the plurality of designs, the message device generates a message corresponding to the subject matter of said one of the plurality of designs.

15. The communication system of claim 1, wherein the message comprises at least one selected from the group consisting of price information, product feature information, and product location information.

16. A communication system, comprising:
a base layer;
a dielectric layer having a first side facing the base layer and a second side facing away from the base layer, wherein the second side has a design concerning a subject thereon;
a transmitter unit; and
a message device, wherein the base layer has at least one contact-activated area comprising a conductive ink printed thereon, the first side of the dielectric layer has at least one contact-making area comprising a conductive ink printed thereon, the first side of the dielectric layer further comprises a dielectric material, the dielectric material biases the contact-making area away from the contact-activated area, and when a force is applied to the design, the contact-making area electrically communicates with the contact-activated area, and the message device generates a message concerning the subject of the design.

17. The communication system of claim 16, wherein the base layer includes a space, the transmitter unit is disposed in the space, and the contact-activated area is in electrical communication with the transmitter unit.

18. The communication system of claim 16, wherein the design is printed on the second side of the dielectric layer.

19. The communication system of claim 16, further comprising a graphics layer adjacent the second side of the dielectric layer, wherein the design is printed on the graphics layer.

20. The communication system of claim 16, wherein the base layer, dielectric layer, transmitter unit, and message device comprise an integral construction.

21. The communication system of claim 20, wherein the construction has an edge thickness ranging from about 0.2 mm to about 0.6 mm.

22. The communication system of claim 20, wherein the construction has a center thickness ranging from about 1 mm to about 5 mm.

23. The communication system of claim 20, wherein the base layer is disposed on a floor.

24. A communication system, comprising:
a housing;
an insert disposed in the housing, the insert having a design concerning a subject thereon and at least one contact-activated area comprising a touch-sensitive switch; and
a message device, wherein when the touch-sensitive switch is touched, the message device generates a message concerning the subject.

25. The communication system of claim 24, further comprising at least one light source, wherein when the touch-sensitive switch is touched, the light source generates light.

26. The communication system of claim 24, wherein the message comprises at least one selected from the group consisting of price information, product feature information, and product location information.

27. A communication system, comprising:
a housing;
an insert associated with the housing, the insert having a design concerning a subject thereon;
a message device;
a coupon having a conductive trigger region, the insert having a detection area comprising a touch-sensitive switch, and when the trigger region is placed adjacent the detection area, the message device generates a message about the subject.

28. The communication system of claim 27, further comprising a coupon dispenser for dispensing a plurality of coupons, wherein each coupon has a conductive trigger region.

29. The communication system of claim 27, wherein the conductive trigger region and the touch-sensitive switch comprise conductive ink.

30. The communication system of claim 27, wherein each coupon further comprises a touch-sensitive switch, and when the touch-sensitive switch is touched, the message device generates a message about the subject.

31. A communications system, comprising:
a layered unit having at least one contact-activated region, a circuit layer and an overlay bearing a design concerning a subject; and
a message device, wherein the layered unit is disposed on a surface, and when one of the contact-activated regions is contacted, the message device generates a message concerning the subject.

32. The communication system of claim 31, wherein the circuit layer includes at least one touch-sensitive switch located in the contact-activated region.

33. The communication system of claim 35, wherein the touch-sensitive switch comprises conductive ink.

34. The communication system of claim 31, wherein the surface comprises a product display case door.

35. A system for guiding a consumer to a product, comprising:
a floor unit having a design concerning the product thereon;
a plurality of lights disposed between the floor unit and the product;
wherein when the floor unit detects the presence of at least one person or object, the plurality of lights are illuminated.

36. The system of claim 35, further comprising a message device, wherein when the floor unit detects the presence of at least one person or object, the message device generates a message concerning the product.

37. The system of claim 35, wherein the floor unit is a layered unit comprising a circuit layer and an overlay bearing the design.
